(19) United States
(12) Patent Application Publication
(10) Pub. No.: US 2004/0254876 A1
(43) Pub. Date: Dec. 16, 2004

(54) Schemes for simulating a financial market

(76) Inventors: Joshua Coval, Cambridge, MA (US); Erik Stafford, Boston, MA (US)

Correspondence Address: FOLEY HOAG, LLP, PATENT GROUP, WORLD TRADE CENTER WEST, 155 SEAPORT BLVD, BOSTON, MA, 02110, US

(21) Appl. No.: 10/461,240

(22) Filed: Jun. 13, 2003

(51) Int. Cl. G06F 17/60

(52) U.S. Cl. 705/37

(57) ABSTRACT

Schemes for simulating a financial market are described herein. In one embodiment, a system for simulating a financial market can comprise simulated market data and non-simulated market data associated with at least one tradable security, at least one server in communication with the data, and at least one agent in communication with the at least one server. The server can be configured to process trade requests associated with the tradable securities. The agent can be configured to provide a trade request associated with a selected one of the tradable securities. The trade request can be based on applying at least one rule to the non-simulated market data and the simulated market data associated with the selected tradable security.

### BACKGROUND

A market simulation is a model of a physical financial market. A financial market simulation can comprise a financial market infrastructure that allows simulation participants to trade securities.

Some existing financial market simulations comprise a participant dependent simulation and a fixed historical price simulation. In the participant dependent simulation, securities prices can be wholly dependent on trades made by the simulation participants. In the fixed historical price simulation, securities prices can be fixed at historical values, independent of trades made by the simulation participants. Since these simulations can be based on simplistic models of physical financial markets, they often do not provide realistic trading experiences for simulation participants.

### SUMMARY

Schemes for simulating a financial market are described herein.

A system for simulating a financial market is described herein. In one embodiment, the system can comprise simulated market data and non-simulated market data associated with at least one tradable security, at least one server in communication with the data, and at least one agent in communication with the at least one server. The server can be configured to process trade requests associated with the tradable securities. The agent can be configured to provide a trade request associated with a selected one of the tradable securities. The trade request can be based on applying at least one rule to the non-simulated market data and the simulated market data associated with the selected tradable security.

In one aspect, the tradable securities can comprise at least one of a bond, a currency, a futures contract, an option contract, and a stock.

In one aspect, the simulated market data and the non-simulated market data can comprise data based on at least one of a limit order book, a market price, and a trading volume associated with the tradable securities.

In one aspect, the non-simulated market data can comprise data based on trading of the tradable securities on a physical financial market during a historical period of time.

In one aspect, the trade requests can comprise at least one of a tradable security, a trade type comprising one of a buy trade type and a sell trade type, an order type comprising one of a limit order type and a market order type, a price, and a quantity.

In one aspect, the at least one server can be configured to update the simulated market data based on processing the trade requests.

In one aspect, the at least one agent can be configured to provide a trade request to adjust the simulated market data based on the non-simulated market data associated with the selected tradable security.

In one aspect, the agent can be configured to provide arbitrage data based on a difference between the simulated market data and the non-simulated market data associated with the selected tradable security.

In one aspect, the agent can be configured to provide a trade request based on applying the at least one rule to the arbitrage data.

In one aspect, the at least one rule can comprise at least one threshold and at least one associated intervention scheme.

In one embodiment, the system can further comprise portfolio data associated with at least one trading entity.

In one aspect, the at least one server can be configured to determine whether the portfolio data associated with a trading entity from which a trade request originated satisfies a margin condition.

In one aspect, the at least one server can be configured to update the portfolio data associated with a trading entity from which a trade request originated based on processing the trade request.

In one aspect, the at least one server can be configured to provide to the at least one trading entity at least one of the simulated market data and the portfolio data associated with the trading entities.

A method for simulating a financial market is described herein. In one embodiment, the method can comprise providing simulated market data and non-simulated market data associated with at least one tradable security, processing trade requests associated with the at least one tradable security, and based on applying at least one rule to the non-simulated market data and the simulated market data, generating a trade request associated with a selected one of the at least one tradable security.

In one aspect, processing can comprise updating the simulated market data based on the trade requests.

In one aspect, generating a trade request can comprise generating a trade request to adjust the simulated market data based on the non-simulated market data associated with the selected tradable security.

In one embodiment, the method can further comprise generating arbitrage data based on a difference between the simulated market data and the non-simulated market data associated with the selected tradable security.

In one aspect, generating a trade request can comprise based on applying the at least one rule to the arbitrage data, generating a trade request to adjust the simulated market data associated with the selected tradable security.

In one embodiment, the method can further comprise providing portfolio data associated with at least one trading entity.

In one aspect, processing can comprise determining whether the portfolio data associated with a trading entity from which a trade request originated satisfies a margin condition.

In one aspect, processing can comprise updating the portfolio data associated with a trading entity from which a trade request originated based on the trade request.

In one embodiment, the method can further comprise providing to the at least one trading entity at least one of the simulated market data and the portfolio data associated with the at least one trading entity.

A processor program for simulating a financial market is described herein. The processor program can be stored on a processor-readable medium. In one embodiment, the processor program can include instructions to cause a processor to provide simulated market data and non-simulated market data associated with at least one tradable security, process trade requests associated with the at least one tradable security, and based on applying at least one rule to the non-simulated market data and the simulated market data, generate a trade request associated with a selected one of the at least one tradable security.

These and other features of the schemes for simulating financial markets described herein can be more fully understood by referring to the following detailed description and accompanying drawings.

### BRIEF DESCRIPTION OF THE DRAWINGS

FIG. 1 schematically illustrates an embodiment of a financial market infrastructure capable of supporting a financial market simulation.

FIGS. 2A-2H schematically illustrate exemplary displays of graphical user interfaces that can facilitate a market simulation.

FIG. 3 schematically illustrates an exemplary display of a graphical user interface that can facilitate administration of a market simulation by a system administrator.

### DETAILED DESCRIPTION

Illustrative embodiments will now be described to provide an overall understanding of the schemes for simulating a financial market described herein. One or more examples of the embodiments are shown in the drawings. Those of ordinary skill in the art will understand that the schemes for simulating a financial market described herein can be adapted and modified to provide devices, methods, schemes, and systems for other applications, and that other additions and modifications can be made to the schemes described herein without departing from the scope of the present disclosure. For example, aspects, components, features, and/or modules of the embodiments can be combined, separated, interchanged, and/or rearranged to generate other embodiments. Such modifications and variations are intended to be comprised within the scope of the present disclosure.

Generally, the schemes described herein can provide a financial market infrastructure that allows simulation participants to place trade requests for tradable securities on a financial market simulation (“market simulations”) that can operate in a manner similar to a physical financial market, e.g. the New York Stock Exchange (NYSE). The tradable securities can comprise bonds, currencies, futures contracts, option contracts, and/or stocks. The tradable securities can be associated with simulated market data, such as limit order books, market prices, and trading volumes. The holdings of the participants on the market simulation can be associated with portfolio data. The results of trade requests made by the participants can be reflected in the simulated market data and the portfolio data.

In embodiments, the securities tradable on the market simulation can be chosen to correspond to securities traded on a physical financial market during a historical period of time. As such, the securities traded on the market simulation can be associated with non-simulated market data, such as limit order books, market prices, and trading volumes, based on actual trading on the physical financial market. Additionally, the securities traded on the market simulation can be associated with news data, such as analyst reports, earnings reports, financial reports, production reports, and other information associated with securities traded on the physical financial market during the historical period of time.

In embodiments, the schemes described herein can provide an initial market simulation in which the tradable securities are associated with initial simulated market data corresponding to non-simulated market data. For example, prices of the tradable securities can be initialized to prices of the corresponding securities on the physical financial market at a historical time. During the simulation, the schemes described herein can provide news data to the simulation participants. Based on the news data, the simulation participants can generate trade requests for the tradable securities.

In embodiments, the schemes described herein can provide one or more agents that can apply one or more arbitrage rules to the simulated market data and the non-simulated market data to generate trade requests for the tradable securities. The trade requests can be based on differences between the simulated market data and the non-simulated market data. For example, the trade requests can be based on a difference between a market price for a tradable security on the market simulation and a non-simulated market price for the corresponding security on the physical financial market at a historical time. By allowing the agents to arbitrage between the market simulation and the physical financial market, the schemes described herein can generate a financial market infrastructure in which prices and other characteristics of tradable securities depend both on simulation participants and historical values, thereby providing a realistic trading experience for brokers, students, teachers, and/or other users.

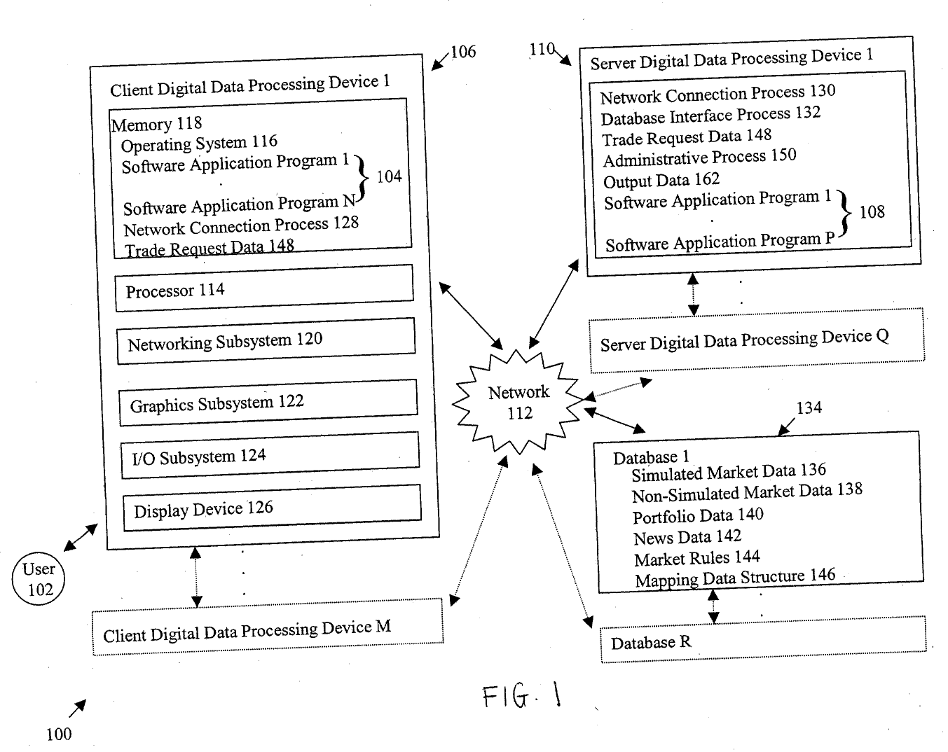

FIG. 1 schematically illustrates an embodiment of a financial market infrastructure capable of supporting a market simulation. As shown in FIG. 1, the illustrated infrastructure 100 can comprise one or more client digital data processing devices 106 (“client”), one or more server digital data processing devices 110 (“server”), and one or more databases 134. The client 106, the server 110, and the database 134 can communicate using one or more data communications networks 112. The features in a digital data processing device are shown as residing in the client 106. Those of ordinary skill in the art will recognize, however, that one or more of the features of the client 106 can be present in the server 110.

As shown in the financial market infrastructure 100 of FIG. 1, a user 102 (e.g. a broker, a student, a teacher, etc.) desiring to participate in a market simulation can execute one or more software application programs 104 (e.g. a web browser and/or another type of application program capable of providing an interface to a market simulation application program) residing on the one or more clients 106 to generate data messages that are routed to, and/or receive data messages generated by, one or more software application programs 108 (e.g. market simulation application programs) residing on the one or more servers 110 via the data communications network 112. A data message can comprise one or more data packets, and the data packets can comprise control information (e.g. addresses of the clients and the servers 106, 110, names/identifiers of the software application programs 104, 108, etc.) and payload data (e.g. data relevant to a market simulation.

The one or more software application programs 104 can comprise one or more software processes (e.g., a calculation process/engine) executing within one or more memories 118 of the client 106. Similarly, the one or more software application programs 108 can comprise one or more software processes executing within one or more memories of the server 110.

The software applications program 108 can comprise one or more sets of instructions and/or other features that can enable the server 110 to simulate a market. As described herein, the software application program 108 can comprise instructions for processing non-simulated market data 136, simulated market data 138, portfolio data 140, news data 142, market rules 144, and/or a mapping data structure 146 into information that can be used to simulate a market. As also described herein, the software application program 108 can interact with a database interface process 132 to support the processing of the foregoing data, rules, and structures.

Although the features and/or operations of the software application programs 104, 108 are described herein as being executed in a distributed fashion (e.g., operations performed on the networked client and servers 106, 110), those skilled in the art will recognize that at least some of the operations of the software application programs 104, 108 can be executed within one or more digital data processing devices that can be connected by a desired digital data path (e.g. point-to-point, networked, data bus, etc.).

The digital data processing device 106, 110 can be a personal computer, a computer workstation (e.g., Sun, Hewlett-Packard), a laptop computer, a server computer, a mainframe computer, a handheld device (e.g., a personal digital assistant, a Pocket Personal Computer (PC), a cellular telephone, etc.), an information appliance, and/or another type of generic or special-purpose, processor-controlled device capable of receiving, processing, and/or transmitting digital data. A processor 114 can refer to the logic circuitry that responds to and processes instructions that drive digital data processing devices and can comprise, without limitation, a central processing unit, an arithmetic logic unit, an application specific integrated circuit, a task engine, and/or combinations, arrangements, or multiples thereof.

The instructions executed by a processor 114 can represent, at a low level, a sequence of “0's” and “1's” that describe one or more physical operations of a digital data processing device. These instructions can be pre-loaded into a programmable memory (e.g. an electrically erasable programmable read-only memory (EEPROM)) that is accessible to the processor 114 and/or can be dynamically loaded into/from one or more volatile (e.g. a random-access memory (RAM), a cache, etc.) and/or non-volatile (e.g. a hard drive, etc.) memory elements communicatively coupled to the processor 114. The instructions can, for example, correspond to the initialization of hardware within the digital data processing devices 106, 110, an operating system 116 that enables the hardware elements to communicate under software control and enables other computer programs to communicate, and/or software application programs 104, 108 that are designed to perform operations for other computer programs, such as operations relating to market simulation. The operating system 116 can support single-threading and/or multi-threading, where a thread refers to an independent stream of execution running in a multi-tasking environment. A single-threaded system can be capable of executing one thread at a time, while a multi-threaded system can be capable of supporting multiple concurrently executing threads and can thus perform multiple tasks simultaneously.

A local user 102 can interact with the client 106 by, for example, viewing a command line, using a graphical and/or other user interface, and entering commands via an input device, such as a mouse, a keyboard, a touch sensitive screen, a track ball, a keypad, etc. The user interface can be generated by a graphics subsystem 122 of the client 106, which renders the interface into an on- or off-screen surface (e.g. on a display device 126 and/or in a video memory). Inputs from the user 102 can be received via an input/output (I/O) subsystem 124 and routed to a processor 114 via an internal bus (e.g. system bus) for execution under the control of the operating system 116.

Similarly, a remote user (not shown) can interact with the digital data processing devices 106, 110 over the data communications network 112. The inputs from the remote user can be received and processed in whole or in part by a remote digital data processing device collocated with the remote user. Alternatively and/or in combination, the inputs can be transmitted back to and processed by the local client 106 or to another digital data processing device via one or more networks using, for example, thin client technology. The user interface of the local client 106 can also be reproduced, in whole or in part, at the remote digital data processing device collocated with the remote user by transmitting graphics information to the remote device and instructing the graphics subsystem of the remote device to render and display at least part of the interface to the remote user. Network communications between two or more digital data processing devices can comprise a networking subsystem 120 (e.g. a network interface card) to establish the communications link between the devices. The communications link interconnecting the digital data processing devices can comprise elements of a data communications network, a point to point connection, a bus, and/or another type of digital data path capable of conveying processor-readable data.

The data communications network 112 can comprise a series of network nodes (e.g. the client and the servers 106, 110) that can be interconnected by network devices and wired and/or wireless communication lines (e.g. public carrier lines, private lines, satellite lines, etc.) that enable the network nodes to communicate. The transfer of data (e.g. messages) between network nodes can be facilitated by network devices, such as routers, switches, multiplexers, bridges, gateways, etc., that can manipulate and/or route data from an originating node to a server node regardless of dissimilarities in the network topology (e.g. bus, star, token ring), spatial distance (local, metropolitan, wide area network), transmission technology (e.g. transfer control protocol/internet protocol (TCP/IP), Systems Network Architecture), data type (e.g. data, voice, video, multimedia), nature of connection (e.g. switched, non-switched, dial-up, dedicated, or virtual), and/or physical link (e.g. optical fiber, coaxial cable, twisted pair, wireless, etc.) between the originating and server network nodes.

FIG. 1 shows processes 128-132, 150. A process can refer to the execution of instructions that interact with operating parameters, message data/parameters, network connection parameters/data, variables, constants, software libraries, and/or other elements within an execution environment in a memory of a digital data processing device that causes a processor to control the operations of the data processing device in accordance with the desired features and/or operations of an operating system, a software application program, and/or another type of generic or specific-purpose application program (or subparts thereof). For example, a network connection process 128, 130 can refer to a set of instructions and/or other elements that enable the digital data processing devices 106, 110, respectively, to establish a communication link and communicate with other digital data processing devices during one or more sessions. A session refers to a series of transactions communicated between two network nodes during the span of a single network connection, where the session begins when the network connection is established and terminates when the connection is ended.

A database interface process 132 can refer to a set of instructions and other elements that enable the server 110 to access one or more databases 134 and/or other types of data repositories to obtain access to, for example, simulated market data 136, non-simulated market data 138, portfolio data 140, news data 142, market rules 144, and/or a mapping data structure 146. The accessed information can then be provided to the software application program 108 for further processing and manipulation.

Simulated market data 136 can comprise data based on a market simulation. An exemplary set of simulated market data 136 can comprise, for example, tables and/or other data structures that provide information on one or more securities tradable on the market simulation (e.g., a limit order book, a market price, a trading volume, etc.), a performance of the market simulation (e.g. a market index), and/or a history of the market simulation (e.g. trade requests placed by simulation participants, trade requests executed, etc.). The one or more securities tradable on the market simulation can comprise one or more of a bond, a currency, a futures contract, an option contract, and a stock. These terms and their interrelationships will be understood by those of ordinary skill in the art. As previously indicated, in embodiments, the securities tradable on the market simulation can be chosen to correspond to securities traded on a physical (e.g. actual) financial market during a historical period of time.

Non-simulated market data 138 can comprise data based on actual trading on a physical financial market during a historical period of time. In embodiments, the historical period of time can comprise a period of time that occurred prior to a time of a trading session of the market simulation. For example, the historical period of time can comprise a period of time that occurred years, months, weeks, days, hours, minutes, and/or seconds prior to the time of a trading session of the market simulation. An exemplary set of non-simulated market data 138 can comprise, for example, tables and/or other data structures that provide information on one or more securities traded on the physical financial market (e.g., a limit order book, a market price, a trading volume, etc.). As described herein, the non-simulated market data 138 can be accessed by agents capable of arbitraging between the market simulation and the physical financial market. In one embodiment, during a simulation, the non-simulated market data 138 cannot be accessed by simulation participants.

Portfolio data 140 can comprise data based on a securities portfolio of a participant in a market simulation. An exemplary set of portfolio data 140 can comprise, for example, tables and/or other data structures that provide information on holdings of a participant on the market simulation, e.g. types and quantities of tradable securities held, current and previous trade requests, and/or current and previous portfolio performance (e.g. cash position).

News data 142 can comprise data relevant to one or more securities traded on a physical financial market during a historical period of time. An exemplary set of news data 142 can comprise, for example, tables and/or other data structures that provide financial information associated with the securities (e.g. analyst reports, earnings reports, production reports, etc.) and information on simulation participants (e.g. trading behavior of one or more participants in a market simulation).

Market rules 144 can refer to rules for administration of a market simulation. An exemplary set of market rules 144 can comprise, for example, trade request rules for processing trade requests and arbitrage rules for generating trade requests based on the simulated market data 136 and the non-simulated market data 138.

A mapping data structure 146 can refer to one or more tables or other data structures that can associate simulated market data 136 with non-simulated market data 138. For example, the mapping data structure 146 can associate simulated market data 136 associated with a tradable security on the market simulation with non-simulated market data 138 associated with a corresponding tradable security on a physical financial market during a historical period of time. In this manner, the mapping data structure 146 can be used by the software application program 108 to compare one or more fields associated with the corresponding tradable securities. An exemplary set of fields that can be compared comprises, for example, a limit order book, a market price, and a trading volume. In embodiments, the software application program 108 can apply the one or more arbitrage rules in market rules 144 to the mapping data structure 146 to generate a trade request for one or more tradable securities on the market simulation.

An administrative process 150 can be executed in a memory of the server 110. The administrative process 150 can refer to a set of instructions and other features that can enable the server 110 to monitor, control, and/or otherwise administer a market simulation. For example, the administrative process 150 can a) maintain and update configuration, runtime, and/or session data for the one or more digital data processing devices 106, 110 and/or the software application programs 104, 108 executing on the devices 106, 110, b) provide buffer management, multi-threaded services, and/or data structure management, c) provide initialization parameters to the digital data processing devices 106, 110 and/or the software application programs 104, 108, d) manage groups of objects (e.g., groups of data elements stored on the digital data processing devices 106, 110 and/or stored or otherwise maintained in the database 134, groups of software application programs 104, 108, groups of users authorized to access software application programs 104, 108, groups of licenses, etc.), e) manage relationships between objects in response to messages communicated between the one or more digital data processing devices 106, 110, f) provide one or more support services (e.g., encryption/decryption, compression, path routing, message parsing, message format manipulation, etc.) to the digital data processing devices 106, 110, and/or g) provide load balancing based on, for example, processor usage/availability, network usage/availability, memory usage/availability, software application program usage/availability, message length, and/or message volume.

Those skilled in the art will recognize that, although the illustrated processes 128-132, 150 and their features have been described with respect to some embodiments, the illustrated processes and/or their features can be combined into one or more processes. The illustrated processes 128-132, 150 can also be provided using a combination of built-in features of one or more commercially-available software application programs and/or in combination with one or more custom-designed software modules.

In one illustrative operation, the processor 114 of the client 106 can execute instructions associated with the software application program 104 (comprising, for example, runtime instructions specified, at least partially, by the local user 102 and/or by another software application program, such as a batch-type program) that can instruct the processor 114 to at least partially control the operation of the graphics subsystem 122 in rendering and displaying a graphical user interface (comprising, for example, one or more menus, windows, and/or other visual objects) on the display device 126 that can support the definition of one or more trade requests and/or other parameters of interest.

Generally, as previously indicated, the schemes described herein can provide a financial market infrastructure that allows one or more simulation participants to place trade requests on a market simulation that operates in a manner similar to a physical financial market. The results of the participants' trade requests can be reflected in the market simulation and in the participant's portfolios, as represented by simulated market data 136 and portfolio data 140, respectively.

Illustrative displays of graphical user interfaces that can facilitate a market simulation will now be described. Those of ordinary skill in the art will understand that these displays are to be interpreted in an exemplary manner and that displays different than those described herein can be used within the scope of the present disclosure. For example, aspects, components, features, and/or modules of the illustrative displays can be combined, separated, interchanged, and/or rearranged to generate other displays.

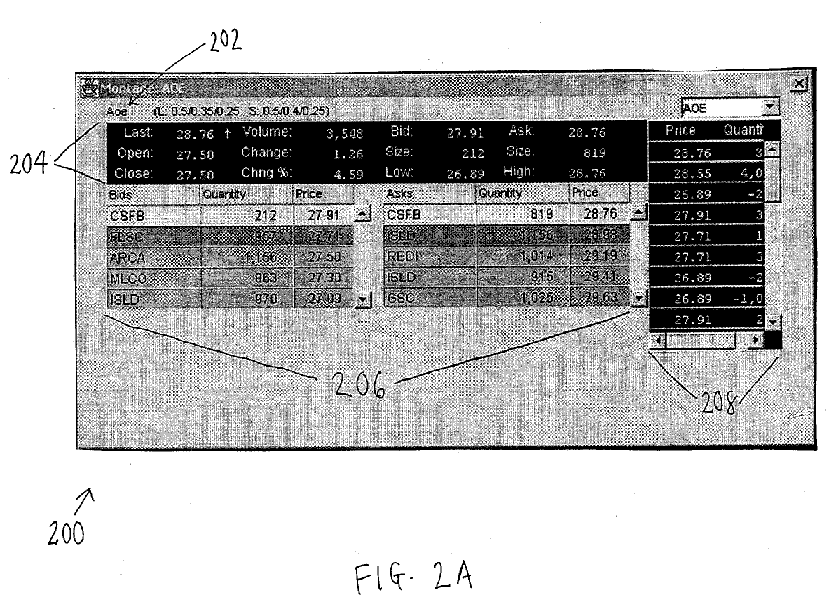

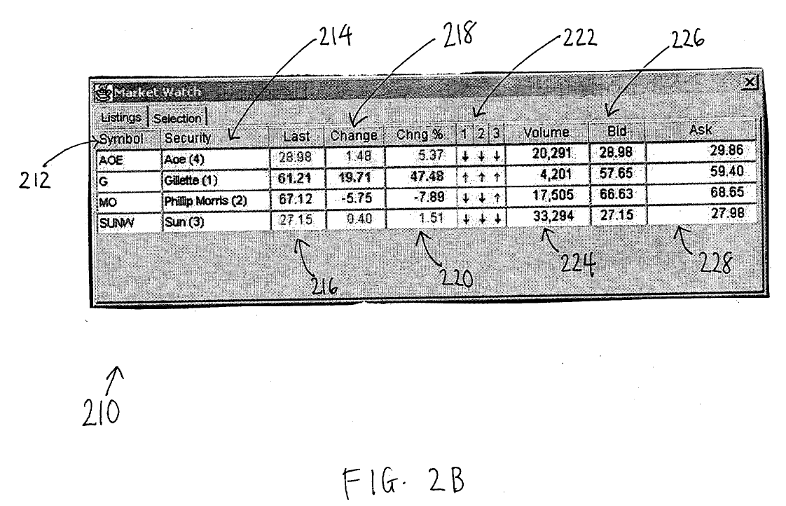

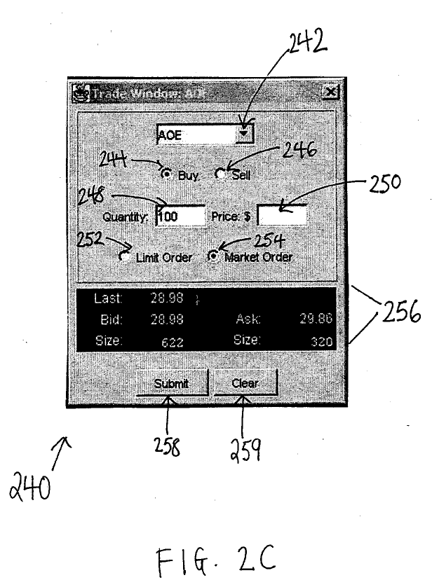

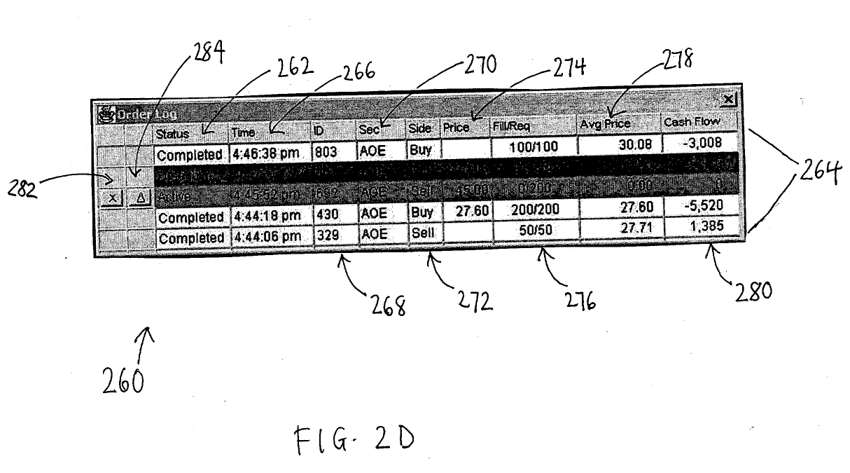

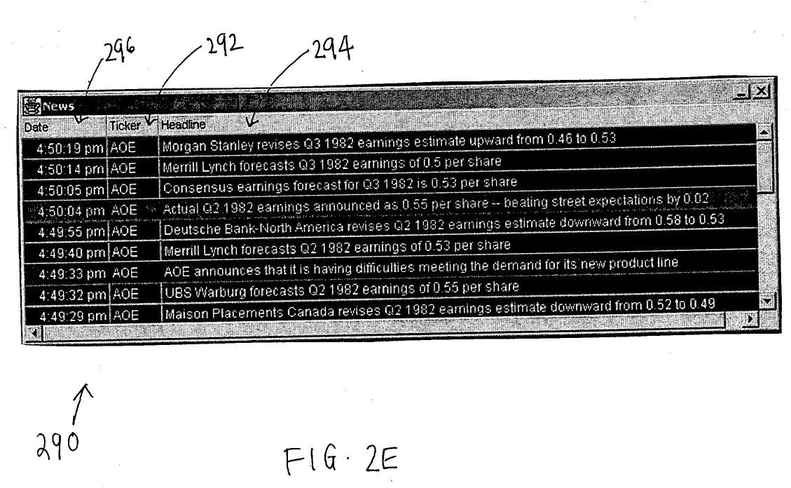

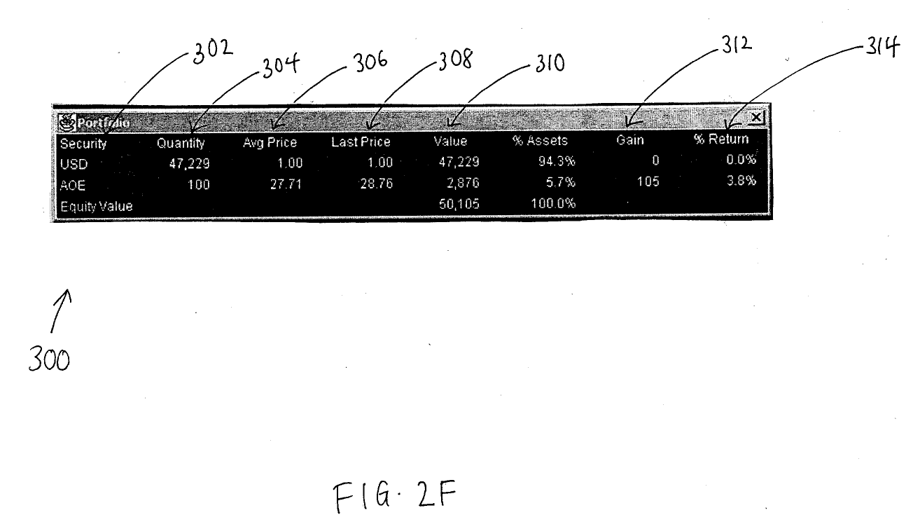

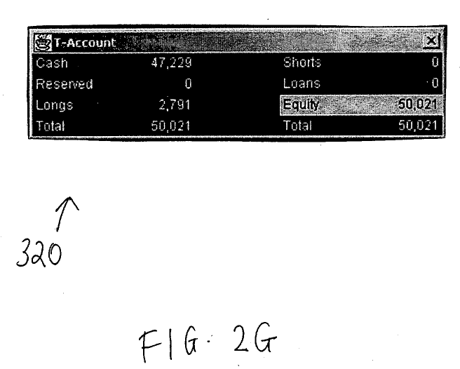

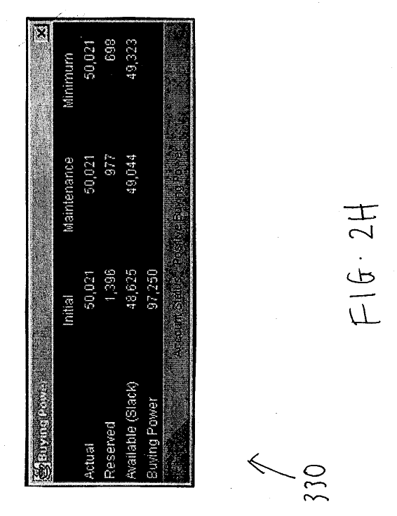

FIG. 2A shows an exemplary montage 200 that can display simulated market data associated with a tradable security on the market simulation. As shown in FIG. 2A, the montage 200 for a tradable security can include a security identifier 202 (such as a security name or a security symbol), statistical information 204 associated with the security (such as a trading volume, a highest bid price, a lowest ask price, etc.), a limit order book 206, and a trading history 208 showing information related to previous executed trades for the tradable security.

FIG. 2B shows an exemplary market watch 210 that can display tradable securities and simulated market data associated with the securities. As shown in FIG. 2B, the market watch 210 can display tradable security symbols 212 and names 214, previous closing prices 216, changes 218 between current market prices and previous closing prices, percent changes 220, change directions (such as positive or negative) 222, trading volumes 224, bid prices 226, and ask prices 228.

FIG. 2C shows an exemplary trade window 240 that can be used by a simulation participant to submit a trade request on the market simulation. As shown in FIG. 2C, the trade window 240 can include a pull-down menu 242 for selecting a tradable security, buy and sell radio buttons 244, 246 for selecting a trade type, a quantity box 248, a price box 250, limit order and market order radio buttons 252, 254, and submit and clear trade request 258, 259 selectors. Based on a selection of a tradable security from the pull-down menu 242, the trade window 240 can display simulated market data 256 associated with the selected tradable security.

FIG. 2D shows an exemplary order log that can display simulated market data relating to trades made by a simulation participant on the market simulation. As shown in FIG. 2D, the order log 260 can display a status 262 of a trade 264 (such as active, completed, or disallowed), a time 266 of the trade 264, a trade identification number 268, a tradable security indicator 270, a trade type 272 (such as buy or sell), a price 274, a fulfillment condition 276, an average price 278 for a traded security, and a cost 280 of the trade 264. A trade 264 having an active trade status 262 can be associated with a cancellation feature 282 for canceling the trade 264 and a hold feature 284 for pausing the trade 264 on the market simulation.

FIG. 2E shows an exemplary news log 290 that can display news data associated with tradable securities. As shown in FIG. 2E, the news log 290 can display a tradable security symbol 292, a headline 294 based on financial information associated with the tradable security 292, and a time 296 of the headline 294.

FIGS. 2F-2H show exemplary displays that can provide portfolio data associated with a simulation participant. As shown in FIG. 2F, a portfolio 300 can display information related to tradable securities held by a simulation participant, such as security names 302, security quantities 304, average purchase prices 306, last or current market prices 308, current market values 310, gains 312, and percent returns 314. As shown in FIG. 2G, a T-account 320 can display a balance sheet for a portfolio of a simulation participant. As shown in FIG. 2H, a buying power 330 can display an account status (such as a positive buying power, a negative buying power, etc.) for a portfolio of a simulation participant.

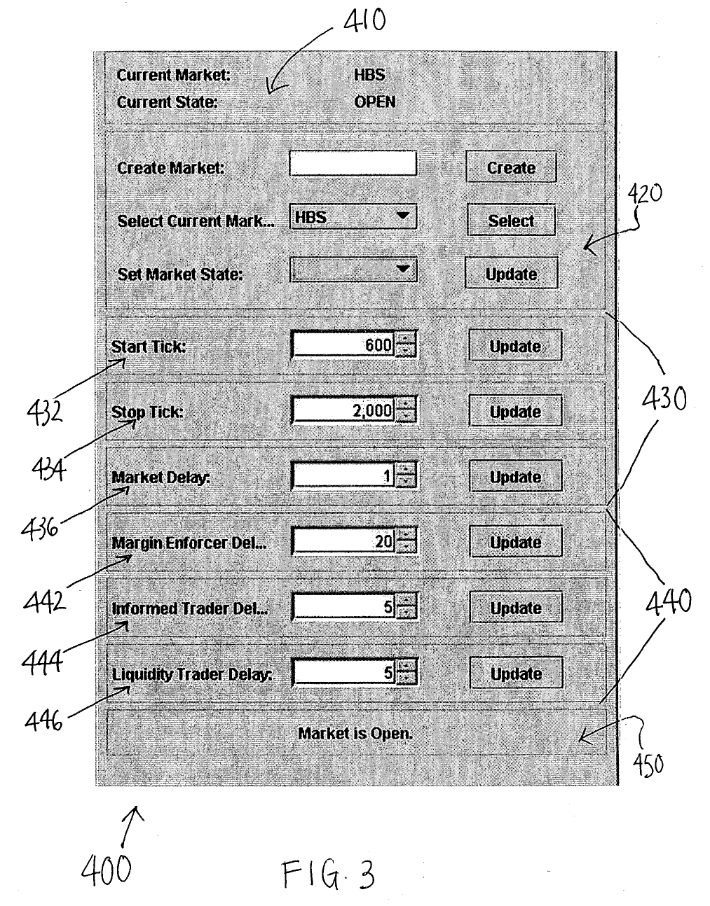

FIG. 3 shows an exemplary market administration display that can facilitate administration of a market simulation by a system administrator or another entity. As shown in FIG. 3, the market administration window 400 can include a market identification region 410 that can display a name and a state (e.g. open, closed, or paused) of a market simulation, a market modification region 420 that can create and/or modify the name and/or the state of a market simulation, a market clock region 430, an agent intervention region 440, and a status region 450 that can display the state of the market simulation.

The exemplary market clock region 430 can display a start tick 432, a stop tick 434, and a market delay 436. A tick can refer to a unit of historical time (e.g. an hour, a day, a week, a year, etc.), and the start and stop ticks 432, 434 can refer to start and stop units of historical time for a market simulation. A market delay 436 can refer to a relationship between a unit of time on the market simulation and a tick. For example, in the illustrated display 400, a tick can refer to one day of historical time, and a second can be the unit of time on the market simulation. As such, in the illustrated display 400, a market delay 436 having a value of 1 can thus indicate that one second on the market simulation corresponds to one day of historical time.

The exemplary agent intervention region 440 displays a margin enforcer delay 442, an informed trader delay 444, and a liquidity trader delay 446. The margin enforcer delay 442 can refer to a delay, in units of time on the market simulation, before the market simulation checks a margin condition for a portfolio of a simulation participant. The informed trader delay 444 and the liquidity trader delay 446 can refer to delays, in units of time on the market simulation, before one or more agents place trades on the market simulation.

In one illustrative operation and with reference to FIGS. 1 and 2C, the software application program 104 executing within the memory 118 of the client 106 can detect a selection of a trade request from the user 102 by, for example, receiving an indication of such selection from the I/O subsystem 124 that detected a mouse click, a keyboard entry, and/or another input event initiated by the user 102. In response to the user selection of a trade request, the software application program 104 can access a set of tradable securities (e.g., bonds, currencies, futures contracts, option contracts, and/or stocks) supported by the software application program 104 and can instruct the graphics subsystem 122 (via the processor 114) to display the supported tradable securities in a graphical user interface (e.g. via the pull-down menu 242). The user 102 can then initiate another input event corresponding to a selection of a tradable security from a set of supported tradable securities. The software application program 104 can detect the user's selection of the tradable security and can display one or more trading types, such as buy and sell, within a hierarchical tree in the graphical user interface, for example. Similar sequences of input events and detections by the software application program 104 can enable the user 102 to specify one or more additional parameters that define a trade request of interest, such as an order type (e.g. a limit order or a market order), a price, and a quantity. These parameters and their interrelationships will be understood by those of ordinary skill in the art.

The trade request (and its associated security, trade type, order type, price, and quantity) 148 selected by the user 102 can be maintained in the memory 118 of the client 106 prior to transmission to the server 110 via the network 112. The software application program 104 can apply one or more rules to the trade request 148 to reduce the occurrence of erroneous trade requests. One or more of these rules can be contained in memory 118. Alternatively and/or in combination, the software application program 104 can access one or more of these rules from market rules 144 on the database 134 via the network 112. As will be understood by those of ordinary skill in the art, in one embodiment, the software application program 104 can apply one or more data validation rules to the trade request 148 to determine the validity of the parameters associated with the trade request 148 and notify the user 102 of errors.

With continuing reference to FIG. 1, the software application program 104 can instruct the network connection process 128 of the client 106 to transmit the parameters associated with the trade request 148 selected by the user 102 to a calculation process or another software process associated with the software application program 108 executing on the server 110 by, for example, encoding, encrypting, and/or compressing the selected trade request 148 into a stream of data packets that can be transmitted between the networking subsystems 120 of the digital data processing devices 106, 110. The network connection process 130 executing on the server 110 can receive, decompress, decrypt, and/or decode the information contained in the data packets and can store such elements in a memory accessible to the software application program 108.

The software application program 108 can access the trade request 148 to obtain information that can enable the software application program 108 to issue a query to the database 134 to access simulated market data 136, non-simulated market data 138, portfolio data 140, news data 142, market rules 144, and/or the mapping data structure 146 that can be used to process the trade request 148. Generally, the software application program 108 can instruct the database interface process 132 to record the trade request 148 in the simulated market data 136 contained on database 134.

As previously described, the trade request 148 for a tradable security can be associated with one or more parameters, such as a security, a trade type (buy or sell), an order type (limit order or market order), a price, and a quantity. The software application program 108 can process the trade request 148 by determining the trade type and order type associated with the trade request 148 and applying to the trade request 148 one or more trading rules from market rules 144 associated with the trade type and order type combination.

Illustrative trading rules for processing the trade request 148 will now be described. Those of ordinary skill in the art will understand that these trading rules are to be interpreted in an exemplary manner and that trading rules different than those described herein can be used within the scope of the present disclosure.

In one embodiment, a trading rule can be designed to process a trade request 148 having a trade type of buy or sell and a limit order type. In such an embodiment, the software application program 108 can instruct the database interface process 132 to access the simulated market data 136 and acquire a lock on the limit order book for the security associated with the trade request 148. Based on the trade request 148, the software application program 108 can update and, subsequently, release the lock on the limit order book. As described herein, the software application program 108 can convert a trade request 148 having a limit order type to a trade request 148 having a market order type based on receiving a different trade request that crosses the trade request 148 having the limit order type.

In one embodiment, a trading rule can be designed to process a trade request having a buy (a sell) trade type and a market order type. In such an embodiment, the software application program 108 can instruct the database interface process 132 to access the simulated market data 136 and process the limit order book for the security associated with the trade request 148 to identify the lowest ask (highest bid) price contained therein, the quantity of tradable security associated with the lowest ask (highest bid) price, and the simulation participant who placed the lowest ask (highest bid) price. The software application program 108 can determine whether the quantity associated with the trade request 148 matches the quantity associated with the lowest ask (highest bid) price and can process the limit order book to identify next-lowest ask (next-highest bid) prices, etc. to aggregate a sufficient quantity. The software application program 108 can acquire locks on the trade request 148 in simulated market data 136 and the portfolios in portfolio data 140 associated with the simulation participants involved in the trade, i.e. the simulation participant who submitted the trade request 148 and the one or more simulation participants who submitted the selected ask (bid) prices. The software application program 108 can execute the trade request 148 by updating the portfolios in portfolio data 140 based on the parameters of the trade request 148. For example, the software application program 108 can modify the portfolios in portfolio data 140 to exchange one security (e.g. a currency) for another security (e.g. a stock) at the lowest ask (highest bid) price. The software application program 108 can release its data locks, update the limit order book for the security to remove the converted limit order, and record the executed trade in the simulated market data 136.

Generally, the software application program 108 can form output data 162 which can be used to report the results of the trade request 148 to the user 102. Based on the trade request 148, the software application program 108 can form a code page (e.g. one or more modules of software code) that can be compiled into an executable, function library, and/or a component containing executable code that can be initiated or otherwise activated by the executable or another executing controller (e.g. an operating system service). The code can be executed to form the output data 162. Once the code is executed to form the output data 162, the software application program 108 can instruct the network connection process 130 to transmit the output data 162 to the software application program 104 of the client 106. Upon receiving the transmitted output data 162, the software application program 104 can display the output data 162 in the graphical user interface, print it in hard copy, mail it electronically to one or more email users, and/or otherwise manipulate, distribute, and/or display the output data 162 to the user 102.

An exemplary market simulation capable of being provided by the financial market infrastructure 100 will now be described. To reduce the complexity of the description, the exemplary market simulation comprises one tradable security corresponding to the stock of American Telephone and Telegraph Corp. (AT&T) traded on the NYSE during the historical period of 1990-1994. Those of ordinary skill in the art will understand that the exemplary market simulation should be interpreted in an illustrative manner and that different market simulations are capable of being provided by the financial market infrastructure 100 within the scope of the present disclosure.

As previously described, the non-simulated market data 138 can comprise data based on actual trading of a tradable security on a physical financial market during a historical period of time. For example, in one embodiment, the non-simulated market data 138 can comprise data based on actual trading of AT&T on the NYSE during 1990-1994. In such an embodiment, the non-simulated market data 138 can comprise a limit order book, a market price, a trading volume, and other characteristics of AT&T on the NYSE during 1990-1994. As such, the non-simulated market data 138 can comprise an actual market price path of AT&T during 1990-1994.

As previously described, the news data 142 can comprise analyst reports, earnings reports, financial reports, production reports, and other information associated with securities traded on a physical financial market during a historical period of time. For example, in one embodiment, the news data 142 can comprise financial information associated with the AT&T stock during 1990-1994. In such an embodiment, the news data 142 can comprise reports prepared by analysts regarding performance of the AT&T stock (e.g. reports prepared by Morningstar®, ValueLine®, etc.). As will be understood by those of ordinary skill in the art, the analyst reports can comprise trading recommendations (e.g. buy, sell, or hold). In such an embodiment, the news data 142 can also comprise reports of earnings and other financial information prepared by AT&T (e.g. reports filed by AT&T with the U.S. Securities and Exchange Commission (SEC)).

Generally, the name of the tradable security on the market simulation can be chosen to be different than the name of the corresponding security traded on the physical financial market during the historical period of time. The news data 142 can also be modified to remove and/or rename identifiers of the security traded on the physical financial market. For example, in one embodiment, the tradable security on the market simulation corresponding to AT&T on the NYSE during 1990-1994 can be renamed with a different non-descriptive name, e.g. XYZ Corp. (XYZ). Renaming the tradable security on the market simulation and removing identifiers of the tradable security in the news data 142 can inhibit simulation participants from seeking information about the tradable security (e.g. an actual market price path) that can adversely affect the integrity of the market simulation.

The market simulation can be prepared for trading by initializing the simulated market data 136 associated with the tradable securities., The simulated market data 136 can be initialized to the non-simulated market data 138. For example, in one embodiment, the simulated market data 136 associated with XYZ can be initialized to the non-simulated market data 138 associated with AT&T. In such an embodiment, the initial limit order book and the initial market price associated with XYZ can be initialized to the actual market price and the actual limit order book of AT&T on the NYSE at a time during 1990-1994, e.g. the end of the first quarter of 1990.

The market simulation can be further prepared for trading by initializing the portfolio data 140 associated with the simulation participants. The portfolio data 140 can be initialized to comprise initial quantities of tradable securities with which to place trade requests on the market simulation. For example, in one embodiment, the portfolio data 140 associated with the simulation participants can be initialized to comprise an initial quantity of currency (e.g. $1000).

Subsequent to initialization, the financial market infrastructure 100 can process trading requests from the simulation participants for the tradable securities on the market simulation based on the schemes previously described herein. In one embodiment, the financial market infrastructure 100 can administer the market simulation based on one or more time measurement modes, such as a market simulation time mode for measuring time on the market simulation and a non-simulated market time mode for measuring time on a corresponding physical financial market, as described further herein. As will be understood by those of ordinary skill in the art, the market simulation time mode and the non-simulated market time mode can be based on one or more clocks (e.g. a processor clock) maintained by the server 110.

In one embodiment, a system administrator can determine an opening time and a closing time for a trading session of the market simulation. For example, in such an embodiment, the system administrator can provide the opening time and the closing time to the server 110, which can administer the market simulation based on the market simulation time mode. The financial market infrastructure 100 can accept trading requests for the tradable securities during the trading session of the market simulation.

During a trading session of the market simulation, the financial market infrastructure 100 can provide the simulated market data 136 to the simulation participants. In embodiments, the financial market infrastructure 136 can transmit the simulated market data 136 to the clients 106 sequentially or simultaneously at times based on the market simulation time mode. For example, in one embodiment, the financial market infrastructure 100 can provide the simulation participants with the simulated market data 136 associated with the tradable security XYZ (e.g. the limit order book, the market price, and/or the trading volume) at update times based on processing trade requests for XYZ. As such, the participants can generate trade requests for XYZ based on the simulated market data 136.

The financial market infrastructure 100 can also provide the news data 142 to the simulation participants. In embodiments, the news data 142 can be associated with historical times. For example, in one embodiment, the news data 142 for AT&T can comprise 1992 analyst reports and 1994 financial reports. As previously described, the financial market infrastructure 100 can administer the market simulation based on a non-simulated market time mode that can measure time on a corresponding physical financial market. In one embodiment, a system administrator can choose a correspondence between the market simulation time mode and the non-simulated market time mode. For example, in such an embodiment, one hour in the market simulation time mode can be chosen to correspond to two years in the non-simulated market time mode. As such, the financial market infrastructure 100 can transmit the news data 142 to the simulation participants based on the times associated with the news data 142 and a time of the non-simulated market time mode. For example, in one embodiment, the financial market infrastructure 100 can transmit 1992 analyst reports of AT&T at a first time in the market simulation time mode and 1994 financial reports of AT&T two hours later than the first time on the market simulation time mode. As such, simulation participants can generate trade requests for XYZ based on the news data 142.

Generally, the schemes described herein can provide one or more agents that can arbitrage between the market simulation and the corresponding physical financial market that provides the non-simulated market data 138. As described herein, the agents can apply one or more arbitrage rules to arbitrage data to generate trade requests for the tradable securities on the market simulation. The agents can be embodied in one or more of the software application programs 108 residing on the server 110. As such, references herein to the agents can be more generally understood to be references to the software application programs 108.

Generally, the arbitrage rules can describe the degree and kind of agent intervention into the market simulation. The arbitrage rules can embody probabilities of agent intervention that can be proportional to differences between corresponding fields in simulated market data 136 and non-simulated market data 138. As such, the arbitrage rules can be used to generate agent trade requests for tradable securities on the market simulation that tend to adjust fields in simulated market data 136 based on corresponding fields in non-simulated market data 138. For example, in embodiments, the arbitrage rules can be used to generate agent trade requests that tend to drive fields in simulated market data 136 to corresponding fields in non-simulated market data 138.

Illustrative arbitrage rules for generating agent trade requests will now be described. Those of ordinary skill in the art will understand that these arbitrage rules are to be interpreted in an exemplary manner and that arbitrage rules different than those described herein can be used within the scope of the present disclosure.

In embodiments, the arbitrage rules can be associated with one or more thresholds referenced to the arbitrage data and one or more intervention schemes associated with the thresholds. The thresholds can represent a degree of agent intervention into the market simulation, while the associated intervention schemes can quantify the agent intervention into the market simulation. The intervention schemes can comprise one or more mathematical and/or statistical expressions, such as linear, polynomial, and exponential. As previously indicated, the arbitrage rules can be comprised in market rules 144.

The agents 108 can use mapping data structure 146 to generate the arbitrage data. As previously described, the mapping data structure 146 can associate the simulated market data 136 associated with a tradable security on the market simulation with the non-simulated market data 138 associated with the corresponding tradable security on the physical financial market during the historical period of time. For example, with continuing reference to the exemplary market simulation previously described herein, the mapping data structure 146 can associate the simulated market data 136 for XYZ with the non-simulated market data 138 for AT&T during the historical period 1990-1994. The agents can compare one or more fields associated with the corresponding tradable securities using the mapping data structure 146 to generate the arbitrage data. As previously described, the one or more fields can comprise a limit order book, a market price, and a trading volume. The arbitrage data can be based on a mathematical and/or statistical relationship between the fields. For example, the arbitrage data can be based on a difference, a difference of squares, a square root of a difference of squares, and/or another mathematical and/or statistical relationship between the fields.

The agents can apply the arbitrage rules to the arbitrage data to generate the agent trade requests. In one embodiment, the agents can apply the arbitrage rules to the arbitrage data to determine a greatest exceeded threshold. In such an embodiment, the agents can apply the intervention scheme associated with the greatest exceeded threshold to the field associated with the tradable security in the simulated market data 136 and the field associated with the corresponding tradable security in the non-simulated market data 138 to generate the agent trade requests. More specifically, the agents can generate trade requests for which the field associated with the tradable security in the simulated market data 136 will approach the field associated with the corresponding tradable security in the non-simulated market data 138 based on the applied intervention scheme.

In one illustrative operation, and with continuing reference to the exemplary market simulation previously described herein, an agent can detect a difference between the market price of XYZ in simulated market data 136 and the market price of AT&T at a historical time in non-simulated market data 138. Based on the difference exceeding a threshold in an arbitrage rule, the agent can generate a trade request for XYZ that can drive the market price of XYZ to the market price of AT&T at the historical time.

As will be understood by those of ordinary skill in the art, the thresholds and/or the intervention schemes in the arbitrage rules can alter the degree of market realism inherent in the financial market infrastructure 100. For example, thresholds that can tolerate more drift between simulated market data 136 and non-simulated market data 138 can decrease the likelihood of agent intervention, while thresholds that can tolerate less drift can increase the likelihood of agent intervention. Also for example, intervention schemes comprising linear expressions tend to decrease the rate at which agent trade requests drive simulated market data 136 to non-simulated market data 138, while intervention schemes comprising polynomial or exponential expressions tend to increase the rate at which agent trade requests drive simulated market data 136 to non-simulated market data 138. As such, based on the arbitrage rules, the thresholds, and the intervention schemes, the financial market infrastructure 100 can provide market simulations that can range from a participant dependent simulation with non-aggressive agents to a fixed historical price simulation with aggressive agents.

In embodiments, during a trading session of a market simulation, the agents can generate the arbitrage data and apply the arbitrage rules to the arbitrage data based on a time scale. The time scale can be dynamic (i.e. the agents can operate after execution of a trade request from a simulation participant), periodic (i.e. the agents can operate at pre-determined times), or random. The time scale can vary during the trading session.

In embodiments, a system administrator can select one or more of the arbitrage rules, the thresholds and the associated intervention schemes, and the time scale of the agents' operation.

As previously described, participants in the market simulations described herein can comprise brokers, students, teachers, traders, and/or other users. Generally, the trading performance of the simulation participants can be compared based on the portfolio data 140 associated with the participants at the closing time of a trading session. In one embodiment, the financial market infrastructure 100 can liquidate the portfolio data 140 at the closing time of the trading session. For example, the financial market infrastructure 100 can generate trade requests comprising sell trade types and market order types to convert holdings of tradable securities on the market simulation to currency based on the prices of the securities at the closing time of the trading session. In such an embodiment, the trading performances of the simulation participants can be compared based on the liquidated portfolio data 140 associated with the participants.

The schemes described herein are not limited to a particular hardware or software configuration, they can find applicability in many computing or processing environments. The schemes can be implemented in hardware or software, or in a combination of hardware and software. In embodiments, the schemes described herein can be implemented in hardware provided by Sun Microsystems, Inc., such as Java® servers executing Enterprise Java Beans. The schemes can be implemented in one or more computer programs, in which a computer program can be understood to comprise one or more processor-executable instructions. The computer programs can execute on one or more programmable processors, and can be stored on one or more storage media readable by the processor, comprising volatile and non-volatile memory and/or storage elements. The programmable processors can access one or more input devices to obtain input data and one or more output devices to communicate output data.

The computer programs can be implemented in high level procedural or object oriented programming language to communicate with a computer system. The computer programs can also be implemented in assembly or machine language. The language can be compiled or interpreted.

The computer programs can be stored on a storage medium or a device (e.g., compact disk (CD), digital video disk (DVD), magnetic disk, internal hard drive, external hard drive, random access memory (RAM), redundant array of independent disks (RAID), or removable memory device) that is readable by a general or special purpose programmable computer for configuring and operating the computer when the storage medium or device is read by the computer to perform the schemes described herein.

While the schemes described herein have been particularly shown and described with reference to certain embodiments, those of ordinary skill in the art will recognize or be able to ascertain many equivalents to the embodiments described herein by using no more than routine experimentation. Such equivalents are intended to be encompassed by the scope of the present disclosure and the appended claims.

As previously described, a trade request can be associated with a security, a trade type, an order type, a price, and/or a quantity. Alternatively and/or in combination, a trade request can be associated with a fulfillment condition and/or an expiration condition. A fulfillment condition can specify whether a trade request can be satisfied by partial or total fulfillment. An expiration condition can specify a time period for executing a trade request. Those of ordinary skill in the art will understand that the market rules 144 described herein can be suitably modified to consider the fulfillment condition and/or the expiration condition.

As previously described, the market rules 144 can comprise trade request rules for processing trade requests and arbitrage rules for generating trade requests based on the simulated market data 136 and the non-simulated market data 138. Alternatively and/or in combination, the market rules 144 can comprise margin rules for performing margin checks on tradable securities and/or portfolios of simulation participants. Those of ordinary skill in the art will understand that the software applications programs 104, 108 can be suitably modified to apply the margin rules to the portfolio data 140 associated with the users 102 to determine whether the trade request 148 satisfies a margin condition and notify the user of a failed margin condition.

As previously described, the arbitrage rules can comprise one or more thresholds and one or more associated intervention schemes. Those of ordinary skill in the art will understand that arbitrage rules different than those described herein can be used to generate agent trade requests that can adjust one or more fields in simulated market data 136 based on one or more corresponding fields in non-simulated market data 138.

As previously described, the tradable securities on the market simulation can comprise bonds, currencies, future contracts, option contracts, and/or stocks. Although the schemes described herein have been described with respect to trades of currencies and stocks, those of ordinary skill in the art will understand that the schemes described herein can be suitably modified to trade bonds, futures contracts, and options contracts. For example, the market rules 144 can be modified to comprise conversion rules for converting one or more tradable securities (e.g. bonds, futures contracts, and options contracts) to different tradable securities (e.g. stocks) and expiration rules for expiring tradable securities (e.g. futures contracts and options contracts) according to a schedule.

As previously described, the schemes described herein can provide news data 142 to simulation participants. The news data 142 can comprise analyst reports, earnings reports, financial reports, production reports, and/or other information associated with securities traded on a physical financial market during a historical period of time. Alternatively and/or in combination, the schemes described herein can be suitably modified to allow simulation participants to purchase news data 142. For example, a user can generate a news data request that can be processed based on schemes similar to those described herein for processing trade requests.

As previously described, a user can access a securities portfolio contained in the portfolio data 140 and comprising holdings of the user on the market simulation. Those of ordinary skill in the art will understand that access to the portfolio data 140 can be based on one or more user authentication schemes.

Accordingly, the appended claims are not to be limited to the embodiments described herein, can comprise practices other than those described, and are to be interpreted as broadly as allowed under prevailing law.

1. A system for simulating a financial market, the system comprising
simulated market data and non-simulated market data associated with at least one tradable security,
at least one server in communication with the data, the at least one server configured to process trade requests associated with the at least one tradable security, and
at least one agent in communication with the at least one server, the at least one agent configured to provide a trade request associated with a selected one of the at least one tradable security, the trade request based on applying at least one rule to the non-simulated market data and the simulated market data associated with the selected tradable security.

2. The system of claim 1, wherein the at least one tradable security comprises at least one of a bond, a currency, a futures contract, an option contract, and a stock.

3. The system of claim 1, wherein the simulated market data and the non-simulated market data comprise data based on at least one of a limit order book, a market price, and a trading volume associated with the at least one tradable security.

4. The system of claim 1, wherein the non-simulated market data comprise data based on trading of the at least one tradable security on a physical financial market during a historical period of time.

5. The system of claim 1, wherein the trade requests comprise at least one of:
a tradable security,
a trade type comprising one of a buy trade type and a sell trade type,
an order type comprising one of a limit order type and a market order type,
a price, and
a quantity.

6. The system of claim 1, wherein the at least one server is configured to update the simulated market data based on processing the trade requests.

7. The system of claim 1, further comprising:
portfolio data associated with at least one trading entity.

8. The system of claim 7, wherein the at least one server is configured to determine whether the portfolio data associated with a trading entity from which a trade request originated satisfies a margin condition.

9. The system of claim 7, wherein the at least one server is configured to update the portfolio data associated with a trading entity from which a trade request originated based on processing the trade request.

10. The system of claim 7, wherein the at least one server is configured to provide to the at least one trading entity at least one of the simulated market data and the portfolio data associated with the at least one trading entity.

11. The system of claim 1, wherein the at least one agent is configured to provide a trade request to adjust the simulated market data based on the non-simulated market data associated with the selected tradable security.

12. The system of claim 1, wherein the at least one agent is configured to provide arbitrage data based on a difference between the simulated market data and the non-simulated market data associated with the selected tradable security.

13. The system of claim 12, wherein the at least one agent is configured to provide a trade request based on applying the at least one rule to the arbitrage data.

14. The system of claim 1, wherein the at least one rule comprises at least one threshold and at least one associated intervention scheme.

15. A method for simulating a financial market, the method comprising:
providing simulated market data and non-simulated market data associated with at least one tradable security,
processing trade requests associated with the at least one tradable security, and
based on applying at least one rule to the non-simulated market data and the simulated market data, generating a trade request associated with a selected one of the at least one tradable security.

16. The method of claim 15, wherein the at least one tradable security comprises at least one of a bond, a currency, a futures contract, an option contract, and a stock.

17. The method of claim 15, wherein the simulated market data and the non-simulated market data comprise data based on at least one of a limit order book, a market price, and a trading volume associated with the at least one tradable security.

18. The method of claim 15, wherein the non-simulated market data comprise data based on trading of the at least one tradable security on a physical financial market during a historical period of time.

19. The method of claim 15, wherein the at least one trade request comprises at least one of:
a tradable security,
a trade type comprising one of a buy trade type and a sell trade type,
an order type comprising one of a limit order type and a market order type,
a price, and
a quantity.

20. The method of claim 15, wherein processing comprises:
updating the simulated market data based on the trade requests.

21. The method of claim 15, further comprising:
providing portfolio data associated with at least one trading entity.

22. The method of claim 21, wherein processing comprises:
determining whether the portfolio data associated with a trading entity from which a trade request originated satisfies a margin condition.

23. The method of claim 21, wherein processing comprises:
updating the portfolio data associated with a trading entity from which a trade request originated based on the trade request.

24. The method of claim 21, further comprising:
providing to the at least one trading entity at least one of the simulated market data and the portfolio data associated with the at least one trading entity.

25. The method of claim 15, wherein generating a trade request comprises:
generating a trade request to adjust the simulated market data based on the non-simulated market data associated with the selected tradable security.

26. The method of claim 15, further comprising:
generating arbitrage data based on a difference between the simulated market data and the non-simulated market data associated with the selected tradable security.

27. The method of claim 26, wherein generating a trade request comprises:
based on applying the at least one rule to the arbitrage data, generating a trade request to adjust the simulated market data associated with the selected tradable security.

28. The method of claim 15, wherein the at least one rule comprises at least one threshold and at least one associated intervention scheme.

29. A processor program for simulating a financial market, the processor program being stored on a processor-readable medium and comprising instructions to cause a processor to:
provide simulated market data and non-simulated market data associated with at least one tradable security,
process trade requests associated with the at least one tradable security, and
based on applying at least one rule to the non-simulated market data and the simulated market data, generate a trade request associated with a selected one of the at least one tradable security.

30. The processor program of claim 29, wherein the at least one tradable security comprises at least one of a bond, a currency, a futures contract, an option contract, and a stock.

31. The processor program of claim 29, wherein the simulated market data and the non-simulated market data comprise data based on at least one of a limit order book, a market price, and a trading volume associated with the at least one tradable security.

32. The processor program of claim 29, wherein the non-simulated market data comprise data based on trading of the at least one tradable security on a physical financial market during a historical period of time.

33. The processor program of claim 29, wherein the at least one trade request comprises at least one of:
a tradable security,
a trade type comprising one of a buy trade type and a sell trade type,
an order type comprising one of a limit order type and a market order type,
a price, and
a quantity.

34. The processor program of claim 29, wherein the instructions to process comprise instructions to:
update the simulated market data based on the trade requests.

35. The processor program of claim 29, further comprising instructions to:
provide portfolio data associated with at least one trading entity.

36. The processor program of claim 35, wherein the instructions to process comprise instructions to:
determine whether the portfolio data associated with a trading entity from which a trade request originated satisfies a margin condition.

37. The processor program of claim 35, wherein the instructions to process comprise instructions to:
update the portfolio data associated with a trading entity from which a trade request originated based on the trade request.

38. The processor program of claim 35, further comprising instructions to:
provide to the at least one trading entity at least one of the simulated market data and the portfolio data associated with the at least one trading entity.

39. The processor program of claim 29, wherein the instructions to generate comprise instructions to:
generate a trade request to adjust the simulated market data based on the non-simulated market data associated with the selected tradable security.

40. The processor program of claim 29, further comprising instructions to:
generate arbitrage data based on a difference between the simulated market data and the non-simulated market data associated with the selected tradable security.

41. The processor program of claim 40, wherein the instructions to generate a trade request comprise instructions to:
based on applying the at least one rule to the arbitrage data, generate a trade request to adjust the simulated market data associated with the selected tradable security.

42. The processor program of claim 29, wherein the at least one rule comprises at least one threshold and at least one associated intervention scheme.
